(19) United States
(12) Patent Application Publication
(10) Pub. No.: US 2026/0332349 A1
(43) Pub. Date: Oct. 22, 2026

(54) INTERFERENCE MANAGEMENT IN WIRELESS NETWORKS

(71) Applicant: QUALCOMM Incorporated, San Diego, CA (US)

(72) Inventors: Alfred ASTERJADHI, San Diego, CA (US); Sherief HELWA, San Diego, CA (US); George CHERIAN, San Diego, CA (US); Abhishek Pramod PATIL, San Diego, CA (US); Gaurang NAIK, San Diego, CA (US)

(21) Appl. No.: 19/186,516

(22) Filed: Apr. 22, 2025

(51) Int. Cl. H04L 5/00; H04B 17/309; H04B 17/318; H04L 1/00; H04L 1/08

(52) U.S. Cl. CPC H04L 5/0053; H04B 17/318; H04B 17/346; H04L 1/0067; H04L 1/08

(57) ABSTRACT

This disclosure provides methods, components, devices and systems for interference management in wireless networks. Some aspects more specifically relate to indicating and managing interference in wireless communications networks. A receiving device may indicate whether unsuccessful reception of a physical layer protocol data unit (PPDU) is due to one or more in-device errors, which may be errors unrelated to channel conditions. For example, the receiving device may set a flag in a response frame to indicate whether at least one in-device error occurred during reception of the PPDU. Additionally, or alternatively, the receiving device may indicate, in the response frame, one or more reasons for the in-device errors, such as whether the in-device error is due to internal interference, coexistence interference, external interference, or any combination thereof. In some examples, the in-device errors may be due to the receiving device operating in a dynamic unavailability operation (DUO) mode.

### TECHNICAL FIELD

This disclosure relates generally to wireless communication and, more specifically, to interference management in wireless networks.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

Some wireless communication networks support feedback mechanisms according to which a wireless device that receives a message may responsively transmit feedback pertaining to the received message. Such feedback may include an indication of whether the wireless device successfully received the message. For example, the wireless device may indicate, via the feedback, an acknowledgement (ACK) of the message in scenarios in which the message is successfully received. By way of further example, the wireless device may indicate, via the feedback, a negative ACK (NACK) of the message in scenarios in which the message is unsuccessfully received.

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method for wireless communications by a first wireless device. The method may include receiving a physical layer protocol data unit (PPDU) including a set of multiple portions, at least a first portion of the set of multiple portions including an identifier of the first wireless device and soliciting a response from the first wireless device and transmitting, in accordance with successfully receiving at least the first portion of the set of multiple portions and unsuccessfully receiving one or more second portions of the set of multiple portions, a block acknowledgement (BA) frame in response to the PPDU, the BA frame including a feedback field indicating at least one in-device error associated with the one or more second portions of the set of multiple portions and one or more reasons for the at least one in-device error.

Another innovative aspect of the subject matter described in this disclosure can be implemented in a first wireless device for wireless communications. The first wireless device may include a processing system that includes processor circuitry and memory circuitry that stores code. The processing system may be configured to cause the first wireless device to receive a PPDU including a set of multiple portions, at least a first portion of the set of multiple portions including an identifier of the first wireless device and soliciting a response from the first wireless device and transmit, in accordance with successfully receiving at least the first portion of the set of multiple portions and unsuccessfully receiving one or more second portions of the set of multiple portions, a BA frame in response to the PPDU, the BA frame including a feedback field indicating at least one in-device error associated with the one or more second portions of the set of multiple portions and one or more reasons for the at least one in-device error.

Another innovative aspect of the subject matter described in this disclosure can be implemented in a first wireless device for wireless communications. The first wireless device may include means for receiving a PPDU including a set of multiple portions, at least a first portion of the set of multiple portions including an identifier of the first wireless device and soliciting a response from the first wireless device and means for transmitting, in accordance with successfully receiving at least the first portion of the set of multiple portions and unsuccessfully receiving one or more second portions of the set of multiple portions, a BA frame in response to the PPDU, the BA frame including a feedback field indicating at least one in-device error associated with the one or more second portions of the set of multiple portions and one or more reasons for the at least one in-device error.

Another innovative aspect of the subject matter described in this disclosure can be implemented in a non-transitory computer-readable medium storing code for wireless communications. The code may include instructions executable by one or more processors to receive a PPDU including a set of multiple portions, at least a first portion of the set of multiple portions including an identifier of the first wireless device and soliciting a response from the first wireless device and transmit, in accordance with successfully receiving at least the first portion of the set of multiple portions and unsuccessfully receiving one or more second portions of the set of multiple portions, a BA frame in response to the PPDU, the BA frame including a feedback field indicating at least one in-device error associated with the one or more second portions of the set of multiple portions and one or more reasons for the at least one in-device error.

In some examples of the method, first wireless devices, and non-transitory computer-readable medium described herein, the one or more reasons for the at least one in-device error include internal interference, coexistence interference, memory usage at the first wireless device, external interference, or any combination thereof.

In some examples of the method, first wireless devices, and non-transitory computer-readable medium described herein, the one or more reasons for the at least one in-device error implicitly indicate that a same coding rate can be used for a retransmission of the PPDU.

Some examples of the method, first wireless devices, and non-transitory computer-readable medium described herein may further include operations, features, means, or instructions for verifying that one or more medium access control protocol data unit (MPDU) delimiters of the PPDU may be impacted by interference in accordance with a value of the one or more MPDU delimiters, where the one or more second portions of the set of multiple portions may be determined as unsuccessfully received in association with verifying that the one or more MPDU delimiters of the PPDU may be impacted by the interference.

In some examples of the method, first wireless devices, and non-transitory computer-readable medium described herein, the feedback field indicates one or more subchannels associated with the at least one in-device error.

In some examples of the method, first wireless devices, and non-transitory computer-readable medium described herein, the feedback field indicates a respective reason for the at least one in-device error for each subchannel of the one or more subchannels.

In some examples of the method, first wireless devices, and non-transitory computer-readable medium described herein, the first portion of the PPDU may be included in a physical layer (PHY) header of the PPDU.

In some examples of the method, first wireless devices, and non-transitory computer-readable medium described herein, the response solicited from the first wireless device may be an immediate response.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example protocol data unit (PDU) usable for communications between a wireless access point (AP) and one or more wireless stations (STAs).

FIG. 3 shows an example physical layer (PHY) protocol data unit (PPDU) usable for communications between a wireless AP and one or more wireless STAs.

FIG. 4 shows a hierarchical format of an example PPDU usable for communications between a wireless AP and one or more wireless STAs.

FIG. 5 shows an example of a signaling diagram between a transmitting wireless device and a receiving wireless device that supports interference management in wireless networks.

FIGS. 6A and 6B show examples of feedback information indicators included in a responsive feedback frame that support interference management in wireless networks.

FIG. 7 shows a block diagram of an example wireless communication device that supports interference management in wireless networks.

FIG. 8 shows a flowchart illustrating an example process performable by or at a first wireless device that supports interference management in wireless networks.

FIG. 9 shows a flowchart illustrating an example process performable by or at a first wireless device that supports interference management in wireless networks.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

In some wireless communication networks, wireless devices may communicate frames including information, such as data and control information. In some examples, a first device (such as a receiving device, which may be a wireless station (STA) or an access point (AP)) may be configured to communicate feedback in response to receiving a frame including data or control information, for example to indicate a reception status of the frame. A second device (such as a transmitting device, which may be a wireless STA or an AP) may transmit a physical layer protocol data unit (PPDU) including one or more frames (or other portions), and may address the PPDU to one or more first devices and indicate that zero or more of the one or more first devices are to respond to the PPDU with feedback information (such as by soliciting an immediate response from the one or more first devices, wherein in some implementations, the immediate response may be sent after a short interframe space (SIFS) duration relative to the end of the received PPDU). A first device may identify whether one or more portions of the PPDU are unsuccessfully received and may respond to the PPDU with a frame including feedback (such as a BA frame). In some embodiments, the frame that includes the feedback is sent in response to another PPDU, which is not the PPDU that contained one or more portions that were unsuccessfully received. For example the PPDU can be a frame that contains one or more data frames, and the PPDU that solicits the immediate response is a subsequent block acknowledgment request (BAR) frame (e.g., a BAR, a multi-traffic identifier (TID) BAR, a multi-user (MU) BAR trigger frame, or a group cast with retries (GCR) MU BAR trigger frame).

In some examples, unsuccessful reception of a portion of the PPDU may be due to errors, which may be related to channel conditions (such as poor channel conditions or channel degradation) or may be related to internal device limitations, or internal or external interference (which may be referred to as an in-device error). The second device may receive the feedback and identify that the one or more portions of the PPDU were unsuccessfully received and may retransmit the PPDU to support successful reception of the one or more portions. In some examples, the second device may adjust communication parameters (such as a data rate or a coding rate) for the retransmission of the PPDU, for example to account for channel degradation between the second device and the first device that might have caused the unsuccessful reception. However, when portions of the PPDU are unsuccessfully received at the first device due to in-device errors (such as primarily due to interference instead of channel conditions), adjusting the communication parameters for the retransmission of the PPDU may not influence the likelihood of successful reception of the retransmission (due to the errors being unrelated to channel conditions), and may adversely affect the performance of the devices communicating the retransmission (such as by introducing additional signaling overhead or processing power associated with communicating the PPDU according to a different coding rate).

Various aspects relate generally to indicating and managing interference and/or other internal limitations in wireless communications networks. Some aspects more specifically relate to a first device (such as a receiving device) indicating whether unsuccessful reception of a PPDU (such as unsuccessful reception of one or more portions of a PPDU) is due, at least in part, to one or more in-device errors. As described herein, an in-device error may be an example of an error related to interference at the first device (such as internal interference, coexistence interference, or external interference) and may otherwise be unrelated to channel conditions (such as a degradation in channel quality between the first device and a second, transmitting, device). To identify an in-device error, the first device may verify whether one or more medium access control (MAC) protocol data unit (MPDU) delimiters of the PPDU are impacted by interference according to the correctness of the MPDU delimiters (such as by verifying that the CRC of each MPDU delimiter passes, and/or by inspecting the contents of certain subfields such as end of frame (EOF) and MPDU length fields in one or more MPDU delimiters that are included in the PPDU, etc.). In some examples, the in-device errors may be due, at least in part, to the first device operating in a dynamic unavailability operation (DUO) mode (such as when the first device is unavailable for one or more durations, for example because it is performing communications via other communication streams), memory usage at the first device (such as when data for other communication streams occupies at least a portion of a buffer at the receiving device), or both, among other examples.

In some examples, the first device may indicate, in a response frame (such as an acknowledgment or a block acknowledgment frame), whether portion(s) of the PPDU were unsuccessfully received due to at least one in-device error (such as via one or more bits in the response frame). For example, the first device may set a flag in the response frame (such as a first bit in the response frame) to indicate whether at least one in-device error occurred during reception of the PPDU. Additionally, or alternatively, the first device may indicate, in the response frame, one or more reasons for the in-device errors, such as whether the in-device error is due to internal interference, coexistence interference, external interference, or any combination thereof. In some examples, the first device may indicate one or more subchannels associated with the in-device errors (such as to support, facilitate, or enable a puncturing of such one or more subchannels in a retransmission or in one or more subsequent PPDU transmissions), a level of interference associated with the in-device errors (such as by reporting a received strength signal indicator (RSSI) or a signal-to-interference-plus-noise ratio (SINR)).

Particular aspects of the subject matter described in this disclosure can be implemented to realize one or more of the following potential advantages. In some examples, by indicating whether errors associated with receiving a PPDU are in-device errors, the described techniques can be used to mitigate adverse effects associated with communicating messages with a reduced coding or data rate, as well as signaling overhead and processing complexity associated with adjusting communication parameters (such as coding rate or data rate) when communicating a retransmission of the PPDU. In accordance with mitigating adverse effects associated with communicating messages with a reduced coding or data rate, as well as signaling overhead and processing complexity, the communicating devices may experience greater spectral efficiency and longer battery lives (or otherwise reduced power consumption), among other benefits. In some examples, by indicating one or more reasons associated with in-device errors, the described techniques can be used to improve likelihood of successful reception of a retransmission of the PPDU, for example by enabling a puncturing of one or more subchannels associated with in-device errors in the retransmission, adjusting timing of a retransmission according to unavailability periods, or both. In accordance with such a greater likelihood of successful communication, the communicating devices may experience higher data rates and greater network capacity, among other benefits.

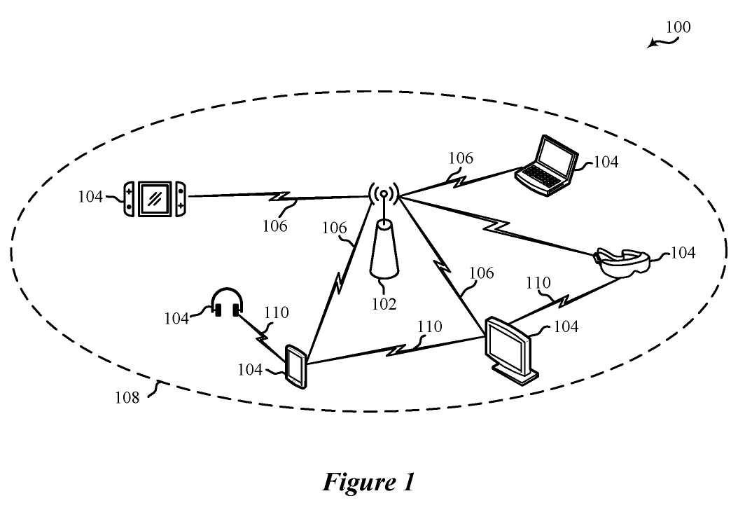

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the 802.11bq Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network’s core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless AP 102 and any number of wireless STAs 104. While only one AP 102 is shown in FIG. 1, the wireless communication network 100 can include multiple APs 102 (such as in an extended service set (ESS) deployment, enterprise network or AP mesh network), or may not include any AP at all (such as in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHz, A GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater RSSI or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz – 7.125 GHz), FR2 (24.25 GHz – 52.6 GHz), FR3 (7.125 GHz – 24.25 GHz), FR4a or FR4–1 (52.6 GHz – 71 GHz), FR4 (52.6 GHz – 114.25 GHz), and FR5 (114.25 GHz – 300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (such as a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (such as for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (such as UHR- or IEEE 802.11bn-compatible) devices for opportunistic access to spectrum that may be otherwise under-utilized.

Puncturing is a wireless communication technique that enables a wireless communication device (such as either an AP 102 or a STA 104) to transmit and receive wireless communications over a portion of a wireless channel exclusive of one or more particular subchannels (hereinafter also referred to as “punctured subchannels”). Puncturing specifically may be used to exclude one or more subchannels from the transmission of a PPDU, including the signaling of the preamble, to avoid interference from a static source, such as an incumbent system, or to avoid interference of a more dynamic nature such as that associated with transmissions by other wireless communication devices in overlapping BSSs (OBSSs). The transmitting device (such as an AP 102 or a STA 104) may puncture the subchannels on which there is interference and in essence spread the data of the PPDU to cover the remaining portion of the bandwidth of the channel. For example, if a transmitting device determines (such as detects, identifies, ascertains, or calculates), in association with a contention operation, that one or more 20 MHz subchannels of a wider bandwidth wireless channel are busy or otherwise not available, the transmitting device implement puncturing to avoid communicating over the unavailable subchannels while still utilizing the remaining portions of the bandwidth. Accordingly, puncturing enables a transmitting device to improve or maximize throughput, and in some instances reduce latency, by utilizing as much of the available spectrum as possible. Static puncturing in particular makes it possible to consistently use wideband channels in environments or deployments where there may be insufficient contiguous spectrum available, such as in the 5 GHz and 6 GHz bands.

In some implementations, a transmitting device (such as an AP 102 or a STA 104) may communicate information to a receiving device (such as an AP 102 or a STA 104). For example, the transmitting device may send a PPDU to the receiving device including information for the reception at the receiving device. In some examples, the PPDU may identify the receiving device (such as indicating that the receiving device is the intended recipient of the PPDU) and may solicit or request a response (such as an immediate response) from the receiving device. For example, the PPDU may request that the receiving device respond to the PPDU with feedback information indicative of a status of reception of the PPDU. The receiving device may send a responsive frame (such as a BA frame) to the transmitting device that includes the feedback information indicative of the status of reception of the PPDU. In some examples, the feedback information may be configured in accordance with the receiving device operating according to a DUO mode (such as by including DUO feedback in the BA frame).

The receiving device may identify that one or more portions of the PPDU were unsuccessfully received, which may be due to one or more errors. In some examples, such errors may be examples of in-device errors (such as errors or interference internal or external to the receiving device or otherwise unrelated to channel conditions between the transmitting device and the receiving device). As an example, in accordance with operating in the DUO mode, the receiving device may switch from communicating with the transmitting device via a communication link 106 to communicating with another wireless device via a communication link 110 during reception of the PPDU (such as during an unavailable period of the receiving device), which may impact reception of portions of the PPDU received while communicating via the communication link 110. The receiving device may identify (such as determine, measure, detect, or otherwise ascertain) that the unsuccessfully received portions of the PPDU are at least partially unrelated to channel conditions (such as due to in-device errors), and may indicate, in the responsive frame, that at least one in-device error occurred during reception of the PPDU. By indicating the presence of in-device errors, the receiving device may prevent the transmitting device from considering the failed reception of the PPDU as an input to a rate selection algorithm of the transmitting device. For example, the transmitting device may not adjust a data or coding rate for a retransmission of the PPDU due to the receiving device indicating the at least one in-device error, thereby mitigating adverse effects associated with communicating messages with a reduced coding or data rate, as well as signaling overhead and processing complexity for the retransmission of the PPDU.

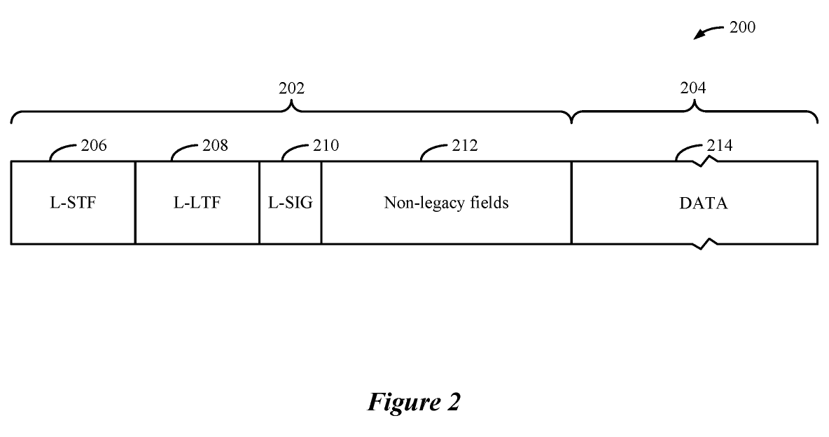

FIG. 2 shows an example protocol data unit (PDU) 200 usable for wireless communication between a wireless AP and one or more wireless STAs. For example, the AP and STAs may be examples of the AP 102 and the STAs 104 described with reference to FIG. 1. The PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device (such as an AP 102 or a STA 104) to perform coarse timing and frequency tracking and automatic gain control (AGC). The L-LTF 208 generally enables the receiving device to perform fine timing and frequency tracking and also to perform an initial estimate of the wireless channel. The L-SIG 210 generally enables the receiving device to determine (such as obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

In some implementations, a receiving device may fail to receive one or more portions of a PDU 200, such as one or more portions of the payload 204. In some examples, the receiving device may identify that the failed portions of the payload 204 are due to in-device errors, which may be errors unrelated to channel conditions between the receiving device and a transmitting device. The receiving device may identify that the PDU 200 solicits a response (such as an immediate response) from the receiving device, and may respond to the PDU 200 with a responsive frame (such as a BA frame). In some examples, the receiving device may indicate, in the responsive frame, that unsuccessfully received portions of the payload 204 are due to in-device errors. By indicating the presence of in-device errors, the receiving device may prevent the transmitting device from considering the failed reception of the PDU 200 as an input to a rate selection algorithm of the transmitting device. For example, the transmitting device may not adjust a data or coding rate for a retransmission of the PDU 200 due to the receiving device indicating the at least one in-device error, thereby mitigating drawbacks of a lowered data or coding rate, signaling overhead, and processing complexity for the retransmission of the PDU 200.

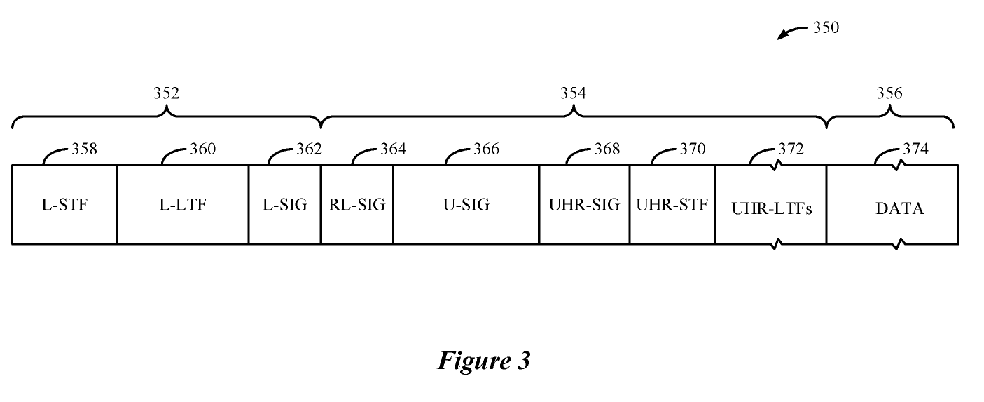

FIG. 3 shows an example PPDU 350 usable for communications between a wireless AP and one or more wireless STAs. For example, the AP and STAs may be examples of the AP 102 and the STAs 104 described with reference to FIG. 1. As shown, the PPDU 350 includes a PHY preamble, that includes a legacy portion 352 and a non-legacy portion 354, and a payload 356 that includes a data field 374. The legacy portion 352 of the preamble includes an L-STF 358, an L-LTF 360, and an L-SIG 362. The non-legacy portion 354 of the preamble includes a repetition of L-SIG (RL-SIG) 364, a universal signal field 366 (referred to herein as “U-SIG 366”) and a UHR signal field 368 (referred to herein as “UHR-SIG 368”). The presence of RL-SIG 364 and U-SIG 366 may indicate to UHR or later version-compliant STAs 104 that the PPDU 350 is a UHR PPDU or a PPDU conforming to any later (post-UHR) version of a new wireless communication protocol conforming to a future IEEE 802.11 wireless communication protocol standard. One or both of U-SIG 366 and UHR-SIG 368 may be structured as, and carry version-dependent information for, other wireless communication protocol versions associated with amendments to the IEEE family of standards beyond UHR. For example, U-SIG 366 may be used by a receiving device (such as an AP 102 or a STA 104) to interpret bits in one or more of UHR-SIG 368 or the data field 374. U-SIG 366 may include one or more universal, version-independent fields and one or more version-dependent fields. Information in the universal fields may include, for example, a version identifier (starting from the IEEE 802.11be amendment and beyond) and channel occupancy and coexistence information (such as a punctured channel indication). The version-dependent fields may include format information fields used for interpreting other fields of U-SIG 366 and UHR-SIG 368 and additional information fields or single user (SU)-specific fields that may be useful to intended recipients. In some implementations, the version-dependent fields may include at least a PPDU format field to indicate a general PPDU format for the PPDU 350 (such as a trigger-based (TB), a single-user (SU), or a multi-user (MU) PPDU format). Like L-STF 358, L-LTF 360, and L-SIG 362, the information in U-SIG 366 and UHR-SIG 368 may be duplicated and transmitted in each of the component 20 MHz channels in instances involving the use of a bonded channel.

The non-legacy portion 354 further includes an additional short training field 370 (referred to herein as “UHR-STF 370,” although it may be structured as, and carry version-dependent information for, other wireless communication protocol versions beyond UHR) and one or more additional long training fields 372 (referred to herein as “UHR-LTFs 372,” although they may be structured as, and carry version-dependent information for, other wireless communication protocol versions beyond UHR). UHR-STF 370 may be used for timing and frequency tracking and AGC, and UHR-LTF 372 may be used for more refined channel estimation.

UHR-SIG 368 may be used by an AP 102 to identify and inform one or multiple STAs 104 that the AP 102 has scheduled uplink (UL) or downlink (DL) resources for them. UHR-SIG 368 may be decoded by each compatible STA 104 served by the AP 102. UHR-SIG 368 also may generally be used by the receiving device to interpret bits in the data field 374. For example, UHR-SIG 368 may include resource unit (RU) allocation information, spatial stream configuration information, and per-user (such as STA-specific) signaling information. Each UHR-SIG 368 may include a common field and at least one user-specific field. In the context of OFDMA, the common field can indicate RU distributions to multiple STAs 104, indicate the RU assignments in the frequency domain, indicate which RUs are allocated for MU-MIMO transmissions and which RUs correspond to OFDMA transmissions, and the number of users in allocations, among other examples. The user-specific fields are assigned to particular STAs 104 and carry STA-specific scheduling information such as user-specific MCS values and user-specific RU allocation information. Such information enables the respective STAs 104 to identify and decode corresponding RUs in the associated data field 374.

In some wireless communications systems, a STA 104 or an AP 102 may transmit the PPDU 350 over bandwidths larger than the 20 MHz, 40 MHz, 80 MHz, 160 MHz, and 320 MHz bandwidths supported by previous generations of IEEE-compliant wireless communication systems. For example, the PPDU 350 may support 480 MHz or 640 MHz bandwidth communications. By increasing the channel bandwidth of the PPDU 350 to 480 MHz or 640 MHz, more data may be transmitted because more or larger RUs are available based on the larger bandwidth, and accordingly, higher peak throughput or increased capacity may be achieved. Parameters for assembling and transmitting the 480 MHz or 640 MHz PPDUs may be defined to account for the larger bandwidths. For example, parameters or designs such as the tone plans, resource unit allocation indications, spatial reuse fields, UHR-STFs 370, UHR-LTFs 372, pilot signal locations, phase shifts, and spectral masks may be optimized or otherwise selected in accordance with the 480 MHz or 640 MHz bandwidths. In some examples, the spatial reuse fields may enable multiple BSSs to operate on the same 480 MHz or 640 MHz bandwidth channels.

In some examples, UHR-capable STAs 104 and APs 102 may support unequal modulation techniques (also referred to as unequal quadrature amplitude modulation (QAM)) with joint encoding across multiple streams for MIMO communications. For example, while different data streams may be transmitted using different spatial streams, or different resource units (RUs), or both, different spatial streams or RUs may be associated with different levels of quality (such as a different signal to noise ratios (SNRs)), and it may be advantageous to use different (unequal) MCSs for different spatial streams or RUs.

To support unequal modulation, an AP 102 may transmit signaling that indicates unequal MCSs across spatial streams or RUs to multiple STAs 104. For example, the AP 102 may transmit an MCS configuration message, which may be an example of a PHY preamble included in control signaling for PHY layer configuration, to indicate the unequal MCSs. In some examples, an MCS field of the MCS configuration message may include entries for unequal QAM schemes across multiple spatial streams, where the multiple spatial streams may be encoding with the same code rate.

In some wireless communication systems, wireless communication devices may support low density parity check (LDPC) coding for forward error correcting purposes to increase the likelihood of accurate data transmission. In some examples, UHR-capable STAs 104 and APs 102 may be capable of selecting among multiple LDPC codeword lengths, including 648 bits, 1296 bits and 1944 bits (defined in legacy IEEE 802.11 wireless communications protocol standards), as well as even longer (extended) codeword lengths, which may increase as operating bandwidths increase, higher modulation orders are introduced, or more spatial streams are available. Using longer LDPC codewords may achieve lower block error rates in some channels, such as channels associated with additive white Gaussian noise. Longer LDPC codewords also may enable more reliable communications in channels with lower SNRs. To facilitate the use of multiple LDPC codeword lengths, a STA 104 and an AP 102 may each include multiple LDPC encoders and multiple LDPC decoders. In some examples, such a STA 104 or AP 102 may connect, aggregate or otherwise utilize multiple encoders to implement a larger single encoder capable of encoding a longer codeword, or similarly, utilize multiple decoders to implement a larger single decoder capable of decoding a longer codeword, which may increase performance gains associated with larger block sizes without substantially increasing the hardware cost or complexity. In some examples, to generate an extended LDPC codeword, a STA 104 or an AP 102 may implement one or more lifting operations to extend a shorter codeword, with each lifting operation extending the previously lifted codeword. A “lifting” operation enables LDPC codes to be implemented using parallel encoding or decoding implementations while also reducing the complexity typically associated with large LDPC codewords. In some examples, a STA 104 or an AP 102 may use mixed codeword lengths for a given transmission. For example, the STA 104 or the AP 102 may encode input bits into one or more codewords having a first, longer codeword length (more than 1944 bits) and one or more codewords having a second, shorter codeword length (1944 bits or less). In such examples, the STA 104 or the AP 102 may perform shortening or puncturing on the codewords having the longer codeword length, or on the codewords having the shorter codeword length, or both.

In some implementations, a receiving device may fail to receive one or more portions of a PPDU 350, such as one or more portions of the payload 356. In some examples, the receiving device may identify that the PPDU 350 is addressed to the receiving device (such as in the PHY preamble or another portion of the PPDU 350) and that the PPDU 350 solicits a response (such as an immediate response) from the receiving device. The receiving device may respond to the PPDU 350 with a responsive frame (such as a BA frame) with feedback information indicating a reception status of the PPDU 350. In some examples, the receiving device identify that failed portions of the payload 356 are due to in-device errors, which may be errors unrelated to channel conditions between the receiving device and a transmitting device. In some examples, the receiving device may indicate, in the responsive frame, that unsuccessfully received portions of the payload 356 are due to in-device errors. By indicating the presence of in-device errors, the receiving device may prevent the transmitting device from considering the failed reception of the PPDU 350 as an input to a rate selection algorithm of the transmitting device. For example, the transmitting device may not adjust a data or coding rate for a retransmission of the PPDU 350 due to the receiving device indicating the at least one in-device error, thereby mitigating adverse effects associated with communicating messages with a reduced coding or data rate, as well as signaling overhead and processing complexity for the retransmission of the PPDU 350.

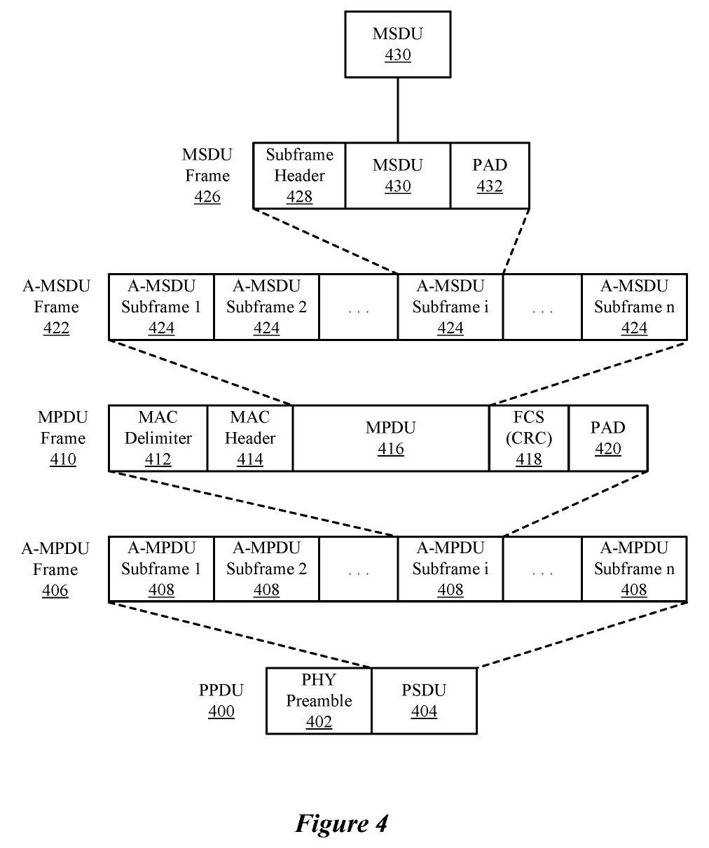

FIG. 4 shows a hierarchical format of an example PPDU usable for communications between a wireless AP and one or more wireless STAs. For example, the AP and STAs may be examples of the AP 102 and the STAs 104 described with reference to FIG. 1. As described, each PPDU 400 includes a PHY preamble 402 and a PSDU 404. Each PSDU 404 may represent (or “carry”) one or more MAC protocol data units (MPDUs) 416. For example, each PSDU 404 may carry an aggregated MPDU (A-MPDU) 406 that includes an aggregation of multiple A-MPDU subframes 408. Each A-MPDU subframe 408 may include an MPDU frame 410 that includes a MAC delimiter 412 and a MAC header 414 prior to the accompanying MPDU 416, which includes the data portion (“payload” or “frame body”) of the MPDU frame 410. Each MPDU frame 410 also may include a frame check sequence (FCS) field 418 for error detection (such as the FCS field 418 may include a cyclic redundancy check (CRC)) and padding bits 420. The MPDU 416 may carry one or more MAC service data units (MSDUs) 430. For example, the MPDU 416 may carry an aggregated MSDU (A-MSDU) 422 including multiple A-MSDU subframes 424. Each A-MSDU subframe 424 may be associated with an MSDU frame 426 and may contain a corresponding MSDU 430 preceded by a subframe header 428 and, in some examples, followed by padding bits 432.

Referring back to the MPDU frame 410, the MAC delimiter 412 may serve as a marker of the start of the associated MPDU 416 and indicate the length of the associated MPDU 416. The MAC header 414 may include multiple fields containing information that defines or indicates characteristics or attributes of data encapsulated within the frame body. The MAC header 414 includes a duration field indicating a duration extending from the end of the PPDU until at least the end of an acknowledgement (ACK) or Block ACK (BA) of the PPDU that is to be transmitted by the receiving wireless communication device. The use of the duration field serves to reserve the wireless medium for the indicated duration and enables the receiving device to establish its network allocation vector (NAV). The MAC header 414 also includes one or more fields indicating addresses for the data encapsulated within the frame body. For example, the MAC header 414 may include a combination of a source address, a transmitter address, a receiver address or a destination address. The MAC header 414 may further include a frame control field containing control information. The frame control field may specify a frame type, for example, a data frame, a control frame, or a management frame.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (such as by generating a message integrity check (MIC) for one or more relevant fields.

Access to the shared wireless medium is generally governed by a distributed coordination function (DCF). With a DCF, there is generally no centralized master device allocating time and frequency resources of the shared wireless medium. On the contrary, before a wireless communication device, such as an AP 102 or a STA 104, is permitted to transmit data, it may wait for a particular time and contend for access to the wireless medium. The DCF is implemented through the use of time intervals (including the slot time (or “slot interval”) and the inter-frame space (IFS). IFS provides priority access for control frames used for proper network operation. Transmissions may begin at slot boundaries. Different varieties of IFS exist including the short IFS (SIFS), the distributed IFS (DIFS), the extended IFS (EIFS), and the arbitration IFS (AIFS). The values for the slot time and IFS may be provided by a suitable standard specification, such as one or more of the IEEE 802.11 family of wireless communication protocol standards.

In some examples, the wireless communication device (such as the AP 102 or the STA 104) may implement the DCF through the use of carrier sense multiple access (CSMA) with collision avoidance (CA) (CSMA/CA) techniques. According to such techniques, before transmitting data, the wireless communication device may perform a clear channel assessment (CCA) and may determine (such as identify, detect, ascertain, calculate, or compute) that the relevant wireless channel is idle. The CCA includes both physical (PHY-level) carrier sensing and virtual (MAC-level) carrier sensing. Physical carrier sensing is accomplished via a measurement of the received signal strength of a valid frame, which is compared to a threshold to determine (such as identify, detect, ascertain, calculate, or compute) whether the channel is busy. For example, if the received signal strength of a detected preamble is above a threshold, the medium is considered busy. Physical carrier sensing also includes energy detection. Energy detection involves measuring the total energy the wireless communication device receives regardless of whether the received signal represents a valid frame. If the total energy detected is above a threshold, the medium is considered busy.

Virtual carrier sensing is accomplished via the use of a network allocation vector (NAV), which effectively serves as a time duration that elapses before the wireless communication device may contend for access even in the absence of a detected symbol or even if the detected energy is below the relevant threshold. The NAV is reset each time a valid frame is received that is not addressed to the wireless communication device. When the NAV reaches 0, the wireless communication device performs the physical carrier sensing. If the channel remains idle for the appropriate IFS, the wireless communication device initiates a backoff timer, which represents a duration of time that the device senses the medium to be idle before it is permitted to transmit. If the channel remains idle until the backoff timer expires, the wireless communication device becomes the holder (or “owner”) of a transmit opportunity (TXOP) and may begin transmitting. The TXOP is the duration of time the wireless communication device can transmit frames over the channel after it has “won” contention for the wireless medium. The TXOP duration may be indicated in the U-SIG field of a PPDU. If, on the other hand, one or more of the carrier sense mechanisms indicate that the channel is busy, a MAC controller within the wireless communication device will not permit transmission.

Each time the wireless communication device generates a new PPDU for transmission in a new TXOP, it randomly selects a new backoff timer duration. The available distribution of the numbers that may be randomly selected for the backoff timer is referred to as the contention window (CW). There are different CW and TXOP durations for each of the four access categories (ACs): voice (AC_VO), video (AC_VI), background (AC_BK), and best effort (AC_BE). This enables particular types of traffic to be prioritized in the network.

In some other examples, the wireless communication device (such as the AP 102 or the STA 104) may contend for access to the wireless medium of a WLAN in accordance with an enhanced distributed channel access (EDCA) procedure. A random channel access mechanism such as EDCA may afford high-priority traffic a greater likelihood of gaining medium access than low-priority traffic. The wireless communication device using EDCA may classify data into different access categories. Each AC may be associated with a different priority level and may be assigned a different range of random backoffs (RBOs) so that higher priority data is more likely to win a TXOP than lower priority data (such as by assigning lower RBOs to higher priority data and assigning higher RBOs to lower priority data). Although EDCA increases the likelihood that low-latency data traffic will gain access to a shared wireless medium during a given contention period, unpredictable outcomes of medium access contention operations may prevent low-latency applications from achieving certain levels of throughput or satisfying certain latency requirements.

Retransmission protocols, such as hybrid automatic repeat request (HARQ), also may offer performance gains. A HARQ protocol may support various HARQ signaling between transmitting and receiving wireless communication devices (such as the AP 102 and the STAs 104 described with reference to FIG. 1) as well as signaling between the PHY and MAC layers to improve the retransmission operations in a wireless communication network. HARQ uses a combination of error detection and error correction. For example, a HARQ transmission may include error checking bits that are added to data to be transmitted using an error-detecting (ED) code, such as a cyclic redundancy check (CRC). The error checking bits may be used by the receiving device to determine if it has properly decoded the received HARQ transmission. In some examples, the original data (information bits) to be transmitted may be encoded with a forward error correction (FEC) code, such as using a low-density parity check (LDPC) coding scheme that systematically encodes the information bits to produce parity bits. The transmitting device may transmit both the original information bits as well as the parity bits in the HARQ transmission to the receiving device. The receiving device may be able to use the parity bits to correct errors in the information bits, thus avoiding a retransmission.

Implementing a HARQ protocol in a wireless communication network may improve reliability of data communicated from a transmitting device to a receiving device. The HARQ protocol may support the establishment of a HARQ session between the two devices. Once a HARQ session is established, if a receiving device cannot properly decode (and cannot correct the errors) a first HARQ transmission received from the transmitting device, the receiving device may transmit a HARQ feedback message to the transmitting device (such as a negative acknowledgment (NACK)) that indicates at least part of the first HARQ transmission was not properly decoded. Such a HARQ feedback message may be different than the traditional Block ACK feedback message type associated with conventional ARQ. In response to receiving the HARQ feedback message, the transmitting device may transmit a second HARQ transmission to the receiving device to communicate at least part of further assist the receiving device in decoding the first HARQ transmission. For example, the transmitting device may include some or all of the original information bits, some or all of the original parity bits, as well as other, different parity bits in the second HARQ transmission. The combined HARQ transmissions may be processed for decoding and error correction such that the complete signal associated with the HARQ transmissions can be obtained.

In some examples, the receiving device may be enabled to control whether to continue the HARQ process or revert to a non-HARQ retransmission scheme (such as an automatic repeat request (ARQ) protocol). Such switching may reduce feedback overhead and increase the flexibility for retransmissions by allowing devices to dynamically switch between ARQ and HARQ protocols during frame exchanges. Some implementations also may allow multiplexing of communications that employ ARQ with those that employ HARQ.

In some implementations, a receiving device may identify that a PPDU 400 solicits a response (such as an immediate response) from the receiving device. For example, the receiving device may successfully receive a first portion of the PPDU 400 that identifies the receiving device (such as indicating that the receiving device is an intended recipient of the PPDU 400) and solicits the response. In some examples, the first portion may be included in the PHY preamble 402 (such as a PHY header of the PPDU 400), or may be included in another portion of the PPDU 400 (such as in a PSDU 404). The receiving device may identify that one or more second portions of the PPDU 400 are unsuccessfully received, and may identify that the failed reception is due to at least one in-device error. As described herein, an in-device error may be an error that is unrelated to channel conditions between the receiving device and a transmitting device, such as errors due to the receiving device operating in a DUO mode and performing communications via communication links separate from the transmitting device during reception of the PPDU 400. In some examples, the receiving device may identify the in-device errors based on failures (such as a CRC failure or a signature failure, among other examples) to detect one or more MPDU delimiters (such as MAC delimiters 415) and/or failures to decode one or more MPDU frames 410 (such as verifying validity of the MPDU delimiters and the FCS fields 418 of the MPDU frames 410).

The receiving device may respond to the PPDU 400 with a responsive frame (such as a BA frame) including feedback indicative of a reception status of the PPDU 400. In some examples, the receiving device may include, in the responsive frame, an indication that at least one in-device error occurred during reception of the PPDU 400. For example, the receiving device may indicate the presence of at least one in-device error, and, in some cases, may include information of the in-device error, such as reasons for the in-device error, subchannel information of the in-device error, a level of interference for the in-device error, or any combination thereof, among other examples. By indicating the presence of in-device errors, the receiving device may prevent the transmitting device from considering the failed reception of the PPDU 400 as an input to a rate selection algorithm of the transmitting device. For example, the transmitting device may not adjust a data or coding rate for a retransmission of the PPDU 400 due to the receiving device indicating the at least one in-device error, thereby mitigating adverse effects associated with communicating messages with a reduced coding or data rate, as well as signaling overhead and processing complexity for the retransmission of the PPDU 400.

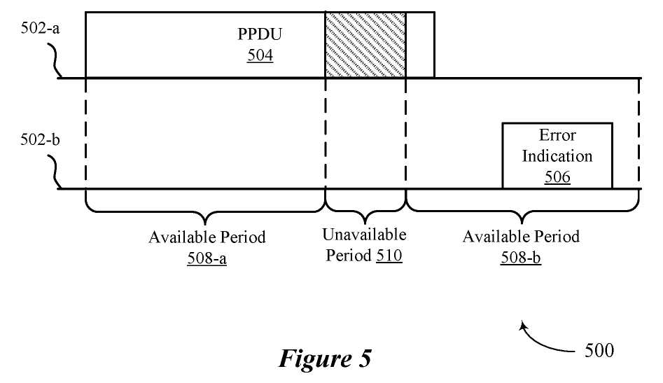

FIG. 5 shows an example of a signaling diagram 500 that supports interference management in wireless networks. The signaling diagram 500 may implement, or be implemented by, one or more aspects of the wireless communication network 100, the PDU 200, the PPDU 350, and the PPDU 400. For example, the signaling diagram 500 shows communications by a first wireless device according to a timeline 502-a (such as a transmitting wireless device) and a second wireless device according to a timeline 502-b (such as a receiving wireless device), each of which may be examples of an AP 102 or a STA 104 described with reference to FIG. 1. In the example of the signaling diagram 500, the transmitting device may send a PPDU 504 to the receiving device, which may include one or more MPDU frames (or any other portions), each of which may be examples of corresponding aspects described with reference to FIGS. 2-4. In some examples, the receiving device may respond to the PPDU 504 with an error indication 506, which may be included in a frame responsive to the PPDU 504 (such as a BA frame). The error indication 506 may indicate whether one or more unsuccessfully received portions of the PPDU 504 are unsuccessfully received due to at least one in-device error and may indicate one or more reasons associated with the at least one in-device error. In some examples, the PPDU 504 may be included in a buffer status report poll (BSRP) trigger frame. In some embodiments the PPDU 504 may include one or more MPDUs that solicit immediate responses (such as quality of service (QoS) data frames with an acknowledgment policy set to implicit BAR, normal acknowledgment, or trigger based (TB) acknowledgement) and may include zero or more triggering frames.

In some examples, by indicating whether errors associated with receiving the PPDU 504 are in-device errors, the techniques of the signaling diagram 500 can be used to mitigate adverse effects associated with communicating messages with a reduced coding or data rate, as well as signaling overhead and processing complexity associated with adjusting communication parameters (such as coding rate or data rate) when communicating a retransmission of the PPDU 504. Additionally, or alternatively, by indicating one or more reasons associated with in-device errors, the described techniques can be used to improve likelihood of successful reception of a retransmission of the PPDU 504, for example by puncturing subchannels associated with in-device errors in the retransmission, adjusting timing of a retransmission according to unavailability periods, or both.

In some examples, the receiving device may operate according to a DUO mode, which may result in the receiving device operating according to one or more available periods 508 (which may refer generally to one or both of an available period 508-a and an available period 508-b) and unavailable periods 510. In the example of the signaling diagram 500, the receiving device may operate in an available period 508-a during a first portion of the timeline 502-b, may operate in an unavailable period 510 during a second portion of the timeline 502-b following the first portion, and may operate in an available period 508-b during a third portion of the timeline 502-b following the second portion. During the unavailable period 510, the receiving device may transition from communicating via a link between the receiving device and the transmitting device to communicating via one or more links separate from the transmitting device (such as to perform Bluetooth communications, LTE communications, or any other suitable communications separate from the transmitting device), which may impact reception of the PPDU 504 when the transmitting device transmits the PPDU 504 during at least a portion of the unavailable period 510. For example, a different transmitting device associated with a link separate from the transmitting device may transmit one or more packets to the receiving device during the unavailable period 510, which may interfere with reception of the PPDU 504 during the unavailable period 510. Additionally, or alternatively, the receiving device may include a buffer (such as in memory of the receiving device) configured to store MPDUs of received packets. The receiving device may share the buffer between communications with the transmitting device and communications with other transmitting devices separate from the transmitting device. In some examples, packets from the other transmitting devices may occupy a portion of the buffer (such as receiving an acknowledgment from a different transmitting device while receiving the PPDU 504), and the receiving device may buffer one or more portions of the PPDU 504 until the buffer is full, which may be before the entire PPDU 504 is received. For example, the unavailable period 510 may correspond to a time when the receiving device experiences buffer overflow during reception of the PPDU 504, where the receiving device may discard one or more portions of the PPDU 504 after the buffer is full.

The PPDU 504 may request that the receiving device respond to the PPDU 504. For example, the PPDU 504 may indicate the receiving device (such as an identifier of the receiving device included in an identifier field (such as a STA ID field) of a PHY header of the PPDU, or in the RA field of the MPDUs carried in the PPDU 504) and may solicit a response (such as an immediate response) from the receiving device. In some implementations, such indications may be also carried in the PHY header (such as an immediate response indication in the PHY header), may be indicted by the MPDU type or subtype, or may be indicted by a presence of an acknowledgment policy in a QoS Control field of the MPDU). The receiving device may transmit, to the transmitting device in accordance with the PPDU 504 soliciting the response from the receiving device, a BA frame including feedback associated with the PPDU 504. The BA frame may include a feedback field (such as a DUO feedback field, which may be in place of or in addition to the one or more per AID TID information fields that provide the acknowledgment status for one or more of the TIDs and/or intended recipient devices) that indicates reception status information of the PPDU 504. In some examples, the BA frame may be a Multi STA BA frame that includes the error indication in a per AID TID information field of the response frame.

The BA frame may include, in the feedback field, an error indication 506. The error indication 506 may include one or more bits and may indicate whether errors associated with reception of the PPDU 504 are in-device errors. In some examples, the error indication 506 may include (or be referred to as) DUO feedback or DUO information. For example, without an indication of in-device errors, the transmitting device may assume that reception errors are due to channel conditions (such as a degradation of channel quality), and may adjust communication parameters (such as a data rate or coding rate) for a retransmission of the PPDU 504. However, when at least a portion of the errors are due to in-device errors, such adjustments may not improve a likelihood of successful reception of the retransmission of the PPDU 504, and may impact performance of communicating the retransmission (such as by introducing adverse effects associated with communicating messages with a reduced data or coding rate, additional signaling overhead, or processing complexity). Accordingly, by indicating whether reception errors are due to in-device errors, the receiving device may implicitly indicate whether communication parameters are to be adjusted for a retransmission of the PPDU 504. In some implementations, if the reception of the PPDU 504 is disrupted and the BA (and the error indication 506) cannot be sent by the receiving device while the receiving device is operating in a coexistence mode (such as communicating with a different wireless device than the transmitting device), the transmitting device may not rely on the absence of the BA frame for rate adaptation. For example, the transmitting device may wait for a BAR BA solicitation to determine whether the absence of the BA frame was due to coexistence interference. In such implementations, the BA frame sent in response to the BAR frame may include an in-device error indication that indicates whether the preceding PPDU (such as a PPDU sent prior to the BAR frame) was impacted by any in-device errors (such as error unrelated to channel conditions).

In some implementations, the receiver may indicate, in the BA frame, which block was impacted by the in-device errors (such as a binary convolutional code (BCC) block, a low density parity check (LDPC) block, a receiver block, or a transmitter block, among other examples). In some implementations, such an indication may support the transmitting device determining whether to transmit subsequent PPDUs 504 using alternative coding techniques.

In some examples, the receiving device may unsuccessfully receive one or more portions of the PPDU 504. The unsuccessful reception may be due to one or more in-device errors (such as internal interference, coexistence interference, memory usage at the receiving device, external interference, or any combination thereof). The receiving device may include, in the BA frame, the error indication 506 to indicate that one or more portions of the PPDU 504 were received unsuccessfully and that at least one in-device error is associated with the one or more portions unsuccessfully received. In some examples, including the error indication 506 with DUO information (such as one or more octets that include the DUO information being present in the BA frame) may correspond to a first transmission scheme for the BA frame. In some examples, the first transmission scheme may align an end time of the BA frame with an end of a TXOP obtained from the transmitting device according to the presence of the one or more octets including the DUO information.

In some examples, the error indication 506 may be a flag (such as one bit) indicating whether the unsuccessful reception is due to at least one in-device error. For example, an internal error flag subfield may be set to 1 to indicate that an internal error occurred during the reception of the soliciting PPDU and may be set to 0 to indicate that no internal errors occurred during the reception of the soliciting PPDU or that the source of the error is unknown. Additionally, or alternatively, the receiving device may provide additional information for the at least one in-device error in the error indication 506. As an example, the error indication 506 may indicate one or more reasons for the in-device error. For example, the error indication 506 may include multiple bits (such as two bits) encoded such that a first value of the error indication 506 (such as 00) may indicate that no errors (if any) are in-device errors, a second value of the error indication 506 (such as 01) may indicate that in-device errors occurred due to internal interference, coexistence interference, or other internal reasons (such as memory usage of the receiving device), a third value of the error indication 506 (such as 10) may indicate that in-device errors occurred due to external interference, and a fourth value of the error indication 506 (such as 11) may indicate that in-device errors occurred due to both internal and external interference. In some examples, the error indication 506 may additionally include a level of interference of the at least one in-device error, for example by including a RSSI value, a SINR value, or both for the at least one in-device error.

In some examples, the error indication 506 may indicate one or more subchannels associated with the at least one in-device error. For example, the error indication 506 may provide a list of the one or more subchannels where interference occurred (such as internal or external interference associated with an in-device error). Additionally, the error indication 506 may indicate the level of interference (such as by respective RSSI values and respective SINR values) associated with each of the one or more subchannels. By including the list of subchannels associated with the at least one in-device error, the receiving device may indicate that subsequent PPDUs 504 sent to the receiving device (such as a retransmission of the PPDU 504) should puncture the one or more subchannels to prevent similar in-device errors from occurring when receiving the subsequent PPDUs 504. Additionally, or alternatively, the error indication 506 may indicate a respective reason for the at least one in-device error for each subchannel of the one or more subchannels indicated by the error indication 506. For example, the error indication 506 may indicate that at least one subchannel is associated with external interference, and the transmitting device may avoid transmissions via the at least one subchannel for the receiving device and other receiving devices that are likely in a similar interference range at the receiving device.

In some other examples, the receiving device may successfully receive the PPDU 504 without experiencing errors. In such examples, the receiving device may determine to not include a per AID TID information field (such as not including one or more octets that include DUO information) in the response frame (which may reduce adverse effects associated with communicating messages at a reduced data or coding rate and signaling overhead of the response to the PPDU 504). Additionally, or alternatively, the receiving device may not include per AID TID information fields in a BA frame that is sent as an initial control frame (ICR). Additionally, or alternatively, the receiving device may include padding bits (such as bits that do not indicate information) in the per AID TID information field (such that the receiving device may include padding per AID TID information field, such as instead of DUO feedback) or may increase a data rate of the response frame, which may support predictability of a TXOP including the response frame and prevent inequality when contending for channel access during a subsequent TXOP (such as by preventing the receiving device having a mismatched NAV duration relative to other contending devices). Additionally, or alternatively, the receiving device may transmit the BA frame as a control response frame (CRF) that is allowed for the DUO mode and sent in response to frame(s) soliciting an acknowledgment (such as an immediate acknowledgment), where the BA frame may be a multi-STA BA frame that includes DUO feedback or includes per AID TID information fields (such as AID TID information fields including padding) instead of the DUO feedback. In some examples, the absence of one or more octets that include DUO information may correspond to a second transmission scheme for the BA frame. In some examples, the second transmission scheme may align an end time of the BA frame with an end of a TXOP obtained by the transmitting device according to the absence of the one or more octets that include the DUO information.

In some examples, indicating whether errors are in-device errors via the error indication 506 may be contingent on the receiving device successfully receiving a first portion of the PPDU 504 that indicates the receiving device and solicits the response from the receiving device. For example, successfully receiving the first portion of the PPDU 504 may inform the receiving device of the identity of the transmitting device, that the receiving device is the intended recipient of the PPDU 504, and that an immediate response is expected form the receiving device following the PPDU 504. In some examples, the first portion may be included in a PHY header of the PPDU 504. For example, the PHY header may include an identifier (such as a STA identifier field) of the receiving device and an acknowledgment policy (such as a normal acknowledgment, an implicit BA request (BAR), no acknowledgment, or a TB acknowledgment) soliciting the response from the receiving device. In some examples, including the first portion in the PHY header may support increased likelihood that the receiving device successfully receives the first portion, for example due to the PHY header being transmitted with a lower MCS (such as in comparison to the payload of the PPDU 504). Alternatively, the indication that the PPDU 504 solicits a response from the receiving device may be included in the payload of the PPDU 504, such as in an MPDU of the PPDU 504 or another portion of the PPDU 504 payload.

In some implementations, indicating whether the receiving device experienced any in-device errors during reception of the PPDU 504 may be performed in accordance with one or more rules. For example, if the receiving device reports in a multi-STA BA frame that frames of the PPDU 504 soliciting an immediate response are successfully received and the multi-STA BA frame includes DUO feedback, the receiving device may set the error indication 506 to 0 (indicating no in-device errors). Additionally, or alternatively, if the receiving device reports in a multi-STA BA frame that at least one frame of the PPDU 504 soliciting an immediate response is not successfully received and the multi-STA BA frame includes DUO feedback, the receiving device may set the error indication 506 to 1 if at least one of the unsuccessful receptions is due to an in-device error that occurred during the reception of the PPDU 504 or may set the error indication 506 to 0 if none of the unsuccessful receptions are due to an in-device error or the source of the error is unknown. In some implementations, if the receiving device does not include DUO feedback in a multi-STA BA frame, the receiving device may indicate that none of the unsuccessful receptions (if any) are due to an in-device error or the source of the error is unknown.

The PPDU 504 may include one or more quality of service (QoS) data frames, which may include an acknowledgment policy equal to a normal acknowledgement, an implicit BAR, or TB acknowledgment, or an management frame that solicits an acknowledgment (such as an action acknowledgment frame)frame (the PPDU 504 may be a management frame soliciting an acknowledgment). If the receiving device determines that at least one of the QoS data frames is soliciting an immediate response (such as by receiving the acknowledgment policy in the QoS data frames or the PHY header of the PPDU 504), the receiving device may determine whether the response is an acknowledgment frame or a BA frame based on the acknowledgment policies and the preceding MPDU delimiters (by inspecting the EOF field of such MPDU delimiters). For example, if the PPDU 504 includes a single MPDU (which may be a QoS data frame with an acknowledgment policy of normal acknowledgment or TB acknowledgment) and the preceding MPDU delimiter has an EOF field equal to 1, the receiving device may determine to respond with an acknowledgment frame or a multi-STA BA frame that includes one per AID TID information field with a context equal to the acknowledgment context. In such examples, the response (such as an acknowledgment frame or a multi-STA BA frame) may be sent in an SU PPDU or a TB PPDU (per the instruction of the acknowledgment policy).

In some examples, the receiving device may not indicate, in the response (such as a multi-STA BA), that an error occurred, even if one or more other delimiters of the MPDU in the PPDU 504 failed (such as if CRCs of the MPDU delimiters have failed). In some other cases, if the receiving device identifies that the MPDU delimiter with an EOF equal to 1 has a CRC that passes (and indicates a nonzero length MPDU) and identifies that the FCS of the MPDU fails, the receiving device may identify that an error occurred and may respond with a multi-STA BA (it may be likely that the first portion of the MAC header of the MPDU is correct since the MPDU delimiter passed). In some examples, the response may not include a per AID TID information field that indicates a context of the acknowledgment context. In some examples, the absence of the per AID TID information field may indicate a negative acknowledgment. Alternatively, the response may include one or multiple per AID TID information fields with DUO feedback (which may include the error indication 506) that indicates the error (such as an in-device error) and reasons for the error.

In some examples, the PPDU 504 may include multiple MPDUs, where at least one of the multiple MPDUs may be a QoS data frame or another frame soliciting an immediate response from the receiving device (such as an action acknowledgment frame). The receiving device may respond (such as with a multi-STA BA) with one or more per AID TID information fields with a context equal to the BA context if the MPDU delimiters include respective EOFs equal to 0 (indicating nonzero length) and at least one of the MPDUs was received correctly (such as if an FCS of the at least one MPDU passes) or at least one MAC header was received correctly (such as if an FCS of one or more MPDUs fails but the receiving device identifies that the MAC header is correct). Alternatively, the receiving device may respond (such as with a multi-STA BA) with one or more per AID TID information fields including DUO feedback (which may include the error indication 506) indicating at least one error (such as an in-device error) and information associated with the at least one error (such as reasons for the in-device error(s), subchannel information for the in-device error(s), a level of interference of the in-device error(s), or any combination thereof, among other examples).

In some examples, the MPDUs of the PPDU 504 may include a triggered response scheduling (TRS) control field. In such examples, the receiving device may send the response in a TB PPDU (such as instead of an SU PPDU or an MU PPDU) in accordance with parameters provided in the TRS control field. In some examples, if the PPDU 504 includes a trigger frame and the receiving device identifies at least one error when receiving zero or more of the subsequent MPDUs (and zero or more MPDU delimiters), the receiving device may send the response in a TB PPDU. For example, the receiving device may include a multi-STA BA (which may include the error indication 506) in the TB PPDU, where the multi-STA BA may include one or more per AID TID information fields with respective context (such as acknowledgment, BA, TB acknowledgment, or no acknowledgment) for the one or more MPDUs that were received successfully and that solicited an immediate response or for the one or more MPDUs including MAC headers that were received successfully. In some examples, the receiving device may not include the one or more per AID TID information fields in the multi-STA BA, where the absence of the one or more per AID TID information fields may indicate the respective context (such as no acknowledgment) for the one or more MPDUs.

It should be noted that while the techniques of the signaling diagram are described in the context of the receiving device being a wireless STA and the transmitting device being a wireless AP, the described techniques may be similarly applicable when the receiving device is a wireless AP and the transmitting device is a wireless STA. For example, when the receiving device is a wireless AP, the AP may receive PSDUs from one or more STAs, may identify errors associated with receiving one or more of the PSDUs (such as in-device errors occurring at the AP), and may respond to the one or more STAs with DUO feedback (which may include the error indication 506). In this example, the AP may include, in the response, one or more per AID TID information fields with respective DUO feedback for the one or more STAs to indicate whether PSDUs sent from the STAs were impacted by errors, and may indicate the additional information for the errors (such as reason(s) for the errors, subchannel information for the errors (such as a reason for an in-device error on a per subchannel basis), levels of interference for the errors, or any combination thereof, among other examples).

Additionally, in some implementations, the transmitting device may extend received feedback information from a first receiving device to one or more other receiving devices, such as to one or more other receiving devices that are in a similar location (or that are otherwise similar to) to the first receiving device. For example, if a first receiving device indicates OBSS interference at one or more specified subchannels as a reason for an in-device error, the transmitting device may assume that one or more other receiving devices located relatively near the first receiving device also may experience similar OBSS interference at the one or more specified subchannels. In such examples, the transmitting device may puncture the one or more specified subchannels in one or more subsequent transmissions to any one or more of the first receiving device or the one or more other receiving devices located near the first receiving device.

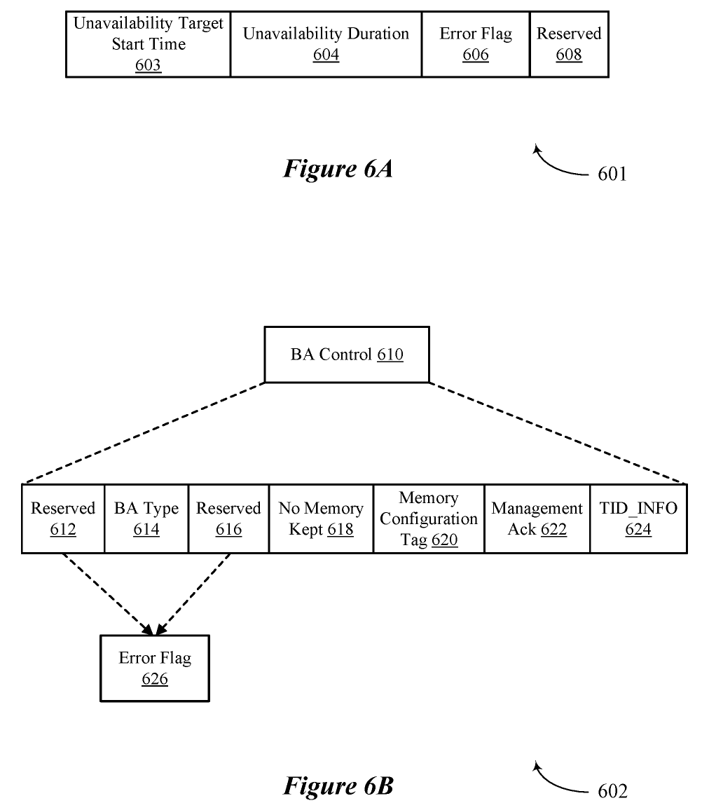

FIGS. 6A and 6B show examples of feedback information indicators 601 and 602 that support interference management in wireless networks. The feedback information indicators 601 and 602 may implement, or be implemented by, one or more aspects of the wireless communication network 100, the PDU 200, the PPDU 350, the PPDU 400, and the signaling diagram 500. For example, the feedback information indicators 601 and 602 may be examples of information fields included in a frame communicated by a receiving device in response to receiving a PPDU from a transmitting device, which may be examples of corresponding aspects and devices described with reference to FIGS. 1-5. In some examples, the feedback information indicators 601 and 602 may be examples of information fields included in a BA frame including DUO feedback, as described with reference to FIG. 5.

The feedback information indicator 601 illustrates an example of information included in a per AID TID information field of a BA frame. For example, the per AID TID information field may include a first set of fields, such as an AID TID information field, a BA starting sequence control field, and a BA bitmap field (not shown). In some examples, the BA starting sequence control field may include a feedback type subfield, which may include a value indicative of a type of feedback included in the BA frame. For example, the receiving device may set the value of the feedback type field to 0 to indicate that the BA frame includes DUO feedback (such as feedback associated with the receiving device operating according to a DUO mode, as described with reference to FIG. 5). When the feedback type indicates DUO feedback, the BA bitmap field may be replaced with a feedback field.

The feedback field may include a set of subfields, such as an unavailability target start time 603 (which may be 9 bits in length), an unavailability duration 604 (which may be 9 bits in length), an error flag 606 (which may be 1 or more bits in length), and one or more reserved bits 608 (which may have a variable length). The unavailability target start time 603 may indicate a time when the receiving device (such as the device transmitting the BA frame) becomes unavailable (such as to perform communications via links separate from the transmitting device that sent a PPDU the BA frame is in response to). The unavailability duration 604 may indicate a duration (such as a duration in units of 64 µs) during which the receiving device is not available following the unavailability target start time 603. The error flag 606 may indicate whether the receiving device identified one or more in-device errors during reception of a PPDU received from the transmitting device. For example, the error flag 606 may be a one-bit indication, where a first value (such as binary ‘1’) of the error flag 606 indicates that the receiving device experienced an in-device error and a second value (such as binary ‘0’) of the error flag 606 indicates that the receiving device did not experience an in-device error. Additionally, or alternatively, the error flag 606 may include additional bits that provide additional information for the in-device error(s), such as reason(s) for the errors, subchannel information for the errors, levels of interference for the errors, or any combination thereof, among other examples.

By including the error flag 606 in the BA frame, the receiving device may improve performance of subsequent PPDU transmissions (such as a retransmission of the PPDU where the error occurred), for example by preventing the transmitting device from adjusting communication parameters (such as a data rate or coding rate) for the subsequent PPDU transmissions when errors are otherwise not related to channel conditions. That is, the receiving device may implicitly indicate, via the error flag 606, whether the transmitting device should consider the failed reception of the PPDU as an input to a rate selection algorithm of the transmitting device, which may prevent adverse effects associated with communicating messages with a reduced data or coding rate, additional signaling overhead and processing complexity associated with communicating the subsequent PPDUs.

The feedback information indicator 602 illustrates an example of information included in a BA control field 610 of a BA frame. The BA control field 610 may include a set of fields, such as a first reserved field 612 (which may be 1 bit in length), a BA type field 614 (which may be 4 bits in length), a second reserved field 616 (which may be 4 bits in length), a no memory kept field 618 (which may be 1 bit in length), a memory configuration tag field 620 (which may be 1 bit in length), a management acknowledgment field 622 (which may be 1 bit in length), and a TID information field 624 (which may be 4 bits in length). In some examples, the receiving device may include an error flag 626 in one or both of the first reserved field 612 and the second reserved field 616. The error flag 626 may include information similar to the error flag 606 described with reference to the feedback information indicator 601. For example, the error flag 626 may be a one-bit indication included in the first reserved field 612 or the second reserved field 616, or may include multiple bits conveyed via both the first reserved field 612 and the second reserved field 616, or contained within the second reserved field 616. As described herein, the error flag 626 may indicate whether the receiving device identified one or more in-device errors during reception of a PPDU received from the transmitting device and may additionally indicate information for the in-device error(s), such as reason(s) for the errors, subchannel information for the errors, levels of interference for the errors, or any combination thereof, among other examples.

By including the error flag 626 in the BA control field 610, in addition to improving performance of subsequent PPDU transmissions, the error flag 626 may be applicable to multiple BA format variants. For example, including the error flag 626 in the BA control field 610 may enable to receiving device to indicate in-device error information via a compressed BA format, an extended compressed BA format, a group cast with retires (GCR) BA format, a multi-STA BA format, or any other suitable BA format. That is, the receiving device may implicitly indicate, via the error flag 626 in any BA format, whether the transmitting device should consider the failed reception of the PPDU as an input to a rate selection algorithm of the transmitting device, which may prevent additional signaling overhead and processing complexity associated with communicating the subsequent PPDUs

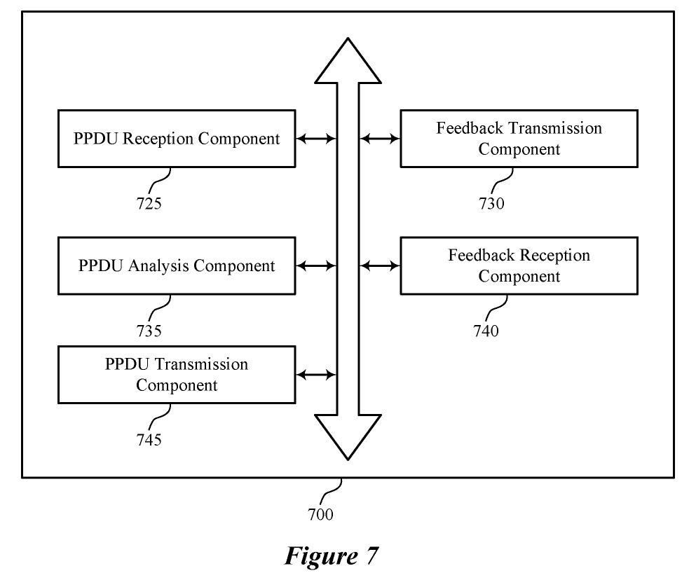

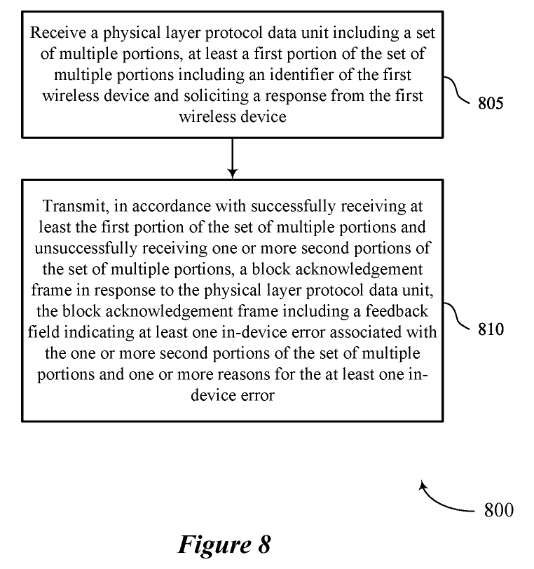

FIG. 7 shows a block diagram of an example wireless communication device 700 that supports interference management in wireless networks. In some examples, the wireless communication device 700 is configured to perform the process 800 described with reference to FIG. 8. The wireless communication device 700 may include one or more chips, SoCs, chipsets, packages, components or devices that individually or collectively constitute or include a processing system. The processing system may interface with other components of the wireless communication device 700, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 700 may transmit the information output from the chip. In such an example, the second interface may refer to an interface between the processing system of the chip and a reception component, such that the wireless communication device 700 may receive information that is then passed to the processing system. In some such examples, the first interface also may obtain information, such as from the transmission component, and the second interface also may output information, such as to the reception component.

The processing system of the wireless communication device 700 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). In some implementations, one or more of the multiple memories may be configured to store processor-executable code that, when executed, may configure one or more of the multiple processors to perform various functions described herein (as part of a processing system). In some other implementations, the processing system may be pre-configured to perform various functions described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 700 can be configurable or configured for use in an AP or STA, such as the AP 102 or the STA 104 described with reference to FIG. 1. In some other examples, the wireless communication device 700 can be an AP or STA that includes such a processing system and other components including multiple antennas. The wireless communication device 700 is capable of transmitting and receiving wireless communications in the form of, for example, wireless packets. For example, the wireless communication device 700 can be configurable or configured to transmit and receive packets in the form of physical layer PPDUs and MPDUs conforming to one or more of the IEEE 802.11 family of wireless communication protocol standards. In some other examples, the wireless communication device 700 can be configurable or configured to transmit and receive signals and communications conforming to one or more 3GPP specifications including those for 5G NR or 6G. In some examples, the wireless communication device 700 also includes or can be coupled with one or more application processors which may be further coupled with one or more other memories. In some examples, the wireless communication device 700 further includes a user interface (UI) (such as a touchscreen or keypad) and a display, which may be integrated with the UI to form a touchscreen display that is coupled with the processing system. In some examples, the wireless communication device 700 may further include one or more sensors such as, for example, one or more inertial sensors, accelerometers, temperature sensors, pressure sensors, or altitude sensors, that are coupled with the processing system. In some examples, the wireless communication device 700 further includes at least one external network interface coupled with the processing system that enables communication with a core network or backhaul network that enables the wireless communication device 700 to gain access to external networks including the Internet.

The wireless communication device 700 includes a PPDU reception component 725, a feedback transmission component 730, a PPDU analysis component 735, a feedback reception component 740, and a PPDU transmission component 745. Portions of one or more of the PPDU reception component 725, the feedback transmission component 730, the PPDU analysis component 735, the feedback reception component 740, and the PPDU transmission component 745 may be implemented at least in part in hardware or firmware. For example, one or more of the PPDU reception component 725, the feedback transmission component 730, the PPDU analysis component 735, the feedback reception component 740, and the PPDU transmission component 745 may be implemented at least in part by at least a processor or a modem. In some examples, portions of one or more of the PPDU reception component 725, the feedback transmission component 730, the PPDU analysis component 735, the feedback reception component 740, and the PPDU transmission component 745 may be implemented at least in part by a processor and software in the form of processor-executable code stored in memory.

The wireless communication device 700 may support wireless communications in accordance with examples as disclosed herein. The PPDU reception component 725 is configurable or configured to receive a physical layer protocol data unit including a set of multiple portions, at least a first portion of the set of multiple portions including an identifier of the first wireless device and soliciting a response from the first wireless device. The feedback transmission component 730 is configurable or configured to transmit, in accordance with successfully receiving at least the first portion of the set of multiple portions and unsuccessfully receiving one or more second portions of the set of multiple portions, a BA frame in response to the physical layer protocol data unit, the BA frame including a feedback field indicating: at least one in-device error associated with the one or more second portions of the set of multiple portions, and one or more reasons for the at least one in-device error.

In some examples, the one or more reasons for the at least one in-device error include internal interference, coexistence interference, memory usage at the first wireless device, external interference, or any combination thereof.

In some examples, the one or more reasons for the at least one in-device error implicitly indicate that a same coding rate can be used for a retransmission of the physical layer protocol data unit.

In some examples, the one or more reasons for the at least one in-device error include channel conditions between the first wireless device and a second wireless device. In some examples, the one or more reasons for the at least one in-device error implicitly request the second wireless device to adjust a coding rate for a retransmission of the physical layer protocol data unit.

In some examples, the PPDU analysis component 735 is configurable or configured to verify that one or more MPDU delimiters of the physical layer protocol data unit are impacted by interference in accordance with a value of the one or more MPDU delimiters, where the one or more second portions of the set of multiple portions are determined as unsuccessfully received in association with verifying that the one or more MPDU delimiters of the physical layer protocol data unit are impacted by the interference.

In some examples, the feedback field indicates one or more subchannels associated with the at least one in-device error.

In some examples, the PPDU reception component 725 is configurable or configured to receive a retransmission of the physical layer protocol data unit in association with transmitting the BA frame, where the one or more subchannels are punctured in the retransmission in accordance with the feedback field indicating the one or more subchannels.

In some examples, the feedback field indicates a respective reason for the at least one in-device error for each subchannel of the one or more subchannels.

In some examples, the feedback field indicates a level of interference of the at least one in-device error, the level of interference including a RSSI, a SINR, or both.

In some examples, the first portion of the physical layer protocol data unit is included in a PHY header of the physical layer protocol data unit.

In some examples, the BA frame is communicated in accordance with a format. In some examples, the format defines a conditional presence of one or more octets that include DUO information.

In some examples, a presence of the one or more octets that include the DUO information corresponds to a first transmission scheme for the BA frame. In some examples, an absence of the one or more octets that include the DUO information corresponds to a second transmission scheme for the BA frame.

In some examples, the first transmission scheme and the second transmission scheme align an end time of the BA frame with an end of a transmission opportunity obtained by a second wireless device that transmits the physical layer protocol data unit in accordance with the presence or the absence, respectively, of the one or more octets that include the DUO information within the BA frame.

In some examples, the response solicited from the first wireless device is an immediate response.

FIG. 8 shows a flowchart illustrating an example process 800 performable by or at a first wireless device that supports interference management in wireless networks. The operations of the process 800 may be implemented by a first wireless device or its components as described herein. For example, the process 800 may be performed by a wireless communication device, such as the wireless communication device 700 described with reference to FIG. 7, operating as or within a wireless AP or a wireless STA. In some examples, the process 800 may be performed by a wireless AP or a wireless STA, such as one of the APs 102 or the STAs 104 described with reference to FIG. 1.

In some examples, in 805, the first wireless device may receive a physical layer protocol data unit including a set of multiple portions, at least a first portion of the set of multiple portions including an identifier of the first wireless device and soliciting a response from the first wireless device. In some implementations, aspects of the operations of 805 may be performed by a PPDU reception component 725 as described with reference to FIG. 7.

In some examples, in 810, the first wireless device may transmit, in accordance with successfully receiving at least the first portion of the set of multiple portions and unsuccessfully receiving one or more second portions of the set of multiple portions, a BA frame in response to the physical layer protocol data unit, the BA frame including a feedback field indicating at least one in-device error associated with the one or more second portions of the set of multiple portions and one or more reasons for the at least one in-device error. In some implementations, aspects of the operations of 810 may be performed by a feedback transmission component 730 as described with reference to FIG. 7.

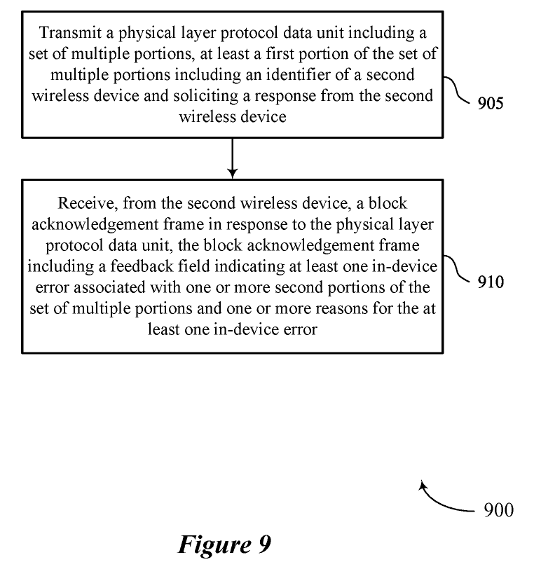

FIG. 9 shows a flowchart illustrating an example process 900 performable by or at a first wireless device that supports interference management in wireless networks. The operations of the process 900 may be implemented by a first wireless device or its components as described herein. For example, the process 900 may be performed by a wireless communication device, such as the wireless communication device 700 described with reference to FIG. 7, operating as or within a wireless AP or a wireless STA. In some examples, the process 900 may be performed by a wireless AP or a wireless STA, such as one of the APs 102 or the STAs 104 described with reference to FIG. 1.

In some examples, in 905, the first wireless device may transmit a physical layer protocol data unit including a set of multiple portions, at least a first portion of the set of multiple portions including an identifier of a second wireless device and soliciting a response from the second wireless device. In some implementations, aspects of the operations of 905 may be performed by a PPDU transmission component 745 as described with reference to FIG. 7.

In some examples, in 910, the first wireless device may receive, from the second wireless device, a BA frame in response to the physical layer protocol data unit, the BA frame including a feedback field indicating at least one in-device error associated with the one or more second portions of the set of multiple portions and one or more reasons for the at least one in-device error. In some implementations, aspects of the operations of 910 may be performed by a feedback transmission component 730 as described with reference to FIG. 7.

Implementation examples are described in the following numbered clauses:

Clause 1: A method for wireless communications at a first wireless device, including: receiving a PPDU including a plurality of portions, at least a first portion of the plurality of portions including an identifier of the first wireless device and soliciting a response from the first wireless device; and transmitting, in accordance with successfully receiving at least the first portion of the plurality of portions and unsuccessfully receiving one or more second portions of the plurality of portions, a BA frame in response to the PPDU, the BA frame including a feedback field indicating: at least one in-device error associated with the one or more second portions of the plurality of portions, and one or more reasons for the at least one in-device error.

Clause 2: The method of clause 1, where the one or more reasons for the at least one in-device error include internal interference, coexistence interference, memory usage at the first wireless device, external interference, or any combination thereof.

Clause 3: The method of any of clauses 1–2, where the one or more reasons for the at least one in-device error implicitly indicate that a same coding rate can be used for a retransmission of the PPDU.

Clause 4: The method of any of clauses 1–2, where the one or more reasons for the at least one in-device error include channel conditions between the first wireless device and a second wireless device, and the one or more reasons for the at least one in-device error implicitly request the second wireless device to adjust a coding rate for a retransmission of the PPDU.

Clause 5: The method of any of clauses 1–4, further including: verifying that one or more MPDU delimiters of the PPDU are impacted by interference in accordance with a value of the one or more MPDU delimiters, where the one or more second portions of the plurality of portions are determined as unsuccessfully received in association with verifying that the one or more MPDU delimiters of the PPDU are impacted by the interference.

Clause 6: The method of any of clauses 1–5, where the feedback field indicates one or more subchannels associated with the at least one in-device error.

Clause 7: The method of clause 6, further including: receiving a retransmission of the PPDU in association with transmitting the BA frame, where the one or more subchannels are punctured in the retransmission in accordance with the feedback field indicating the one or more subchannels.

Clause 8: The method of any of clauses 6–7, where the feedback field indicates a respective reason for the at least one in-device error for each subchannel of the one or more subchannels.

Clause 9: The method of any of clauses 1–8, where the feedback field indicates a level of interference of the at least one in-device error, the level of interference including a RSSI, a SINR, or both.

Clause 10: The method of any of clauses 1–9, where the first portion of the PPDU is included in a PHY header of the PPDU.

Clause 11: The method of any of clauses 1–10, where the BA frame is communicated in accordance with a format, and the format defines a conditional presence of one or more octets that include DUO information.

Clause 12: The method of clause 11, where a presence of the one or more octets that include the DUO information corresponds to a first transmission scheme for the BA frame, and an absence of the one or more octets that include the DUO information corresponds to a second transmission scheme for the BA frame.

Clause 13: The method of clause 12, where the first transmission scheme and the second transmission scheme align an end time of the BA frame with an end of a transmission opportunity obtained by a second wireless device that transmits the PPDU in accordance with the presence or the absence, respectively, of the one or more octets that include the DUO information within the BA frame.

Clause 14: The method of any of clauses 1–13, where the response solicited from the first wireless device is an immediate response.

Clause 15: A first wireless device for wireless communications, including a processing system that includes processor circuitry and memory circuitry that stores code, the processing system configured to cause the first wireless device to perform a method of any of clauses 1–14.

Clause 16: A first wireless device for wireless communications, including at least one means for performing a method of any of clauses 1–14.

Clause 17: A non-transitory computer-readable medium storing code for wireless communications, the code including instructions executable by one or more processors to perform a method of any of clauses 1–14.

As used herein, the term “determine” or “determining” encompasses a wide variety of actions and, therefore, “determining” can include calculating, computing, processing, deriving, investigating, looking up (such as via looking up in a table, a database or another data structure), inferring, ascertaining, measuring, and the like. Also, “determining” can include receiving (such as receiving information), accessing (such as accessing data stored in memory), transmitting (such as transmitting information) and the like. Also, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information. In other words, as used herein, the phrase “based on” shall be construed in the same manner as the phrases “based at least in part on,” “associated with”, or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. An apparatus for wireless communication at a first wireless device, comprising:
a processing system that includes processor circuitry and memory circuitry that stores code, the processing system configured to cause the apparatus to:
receive a physical layer protocol data unit comprising a plurality of portions, at least a first portion of the plurality of portions including an identifier of the first wireless device and soliciting a response from the first wireless device; and
transmit, in accordance with successfully receiving at least the first portion of the plurality of portions and unsuccessfully receiving one or more second portions of the plurality of portions, a block acknowledgement frame in response to the physical layer protocol data unit, the block acknowledgement frame comprising a feedback field indicating:
at least one in-device error associated with the one or more second portions of the plurality of portions, and
one or more reasons for the at least one in-device error.

2. The apparatus of claim 1, wherein the one or more reasons for the at least one in-device error comprise internal interference, coexistence interference, memory usage at the first wireless device, external interference, or any combination thereof.

3. The apparatus of claim 1, wherein the one or more reasons for the at least one in-device error implicitly indicate that a same coding rate can be used for a retransmission of the physical layer protocol data unit.

4. The apparatus of claim 1, wherein:
the one or more reasons for the at least one in-device error comprise channel conditions between the first wireless device and a second wireless device, and
the one or more reasons for the at least one in-device error implicitly request the second wireless device to adjust a coding rate for a retransmission of the physical layer protocol data unit.

5. The apparatus of claim 1, wherein the processing system is further configured to cause the apparatus to:
verify that one or more medium access control protocol data unit delimiters of the physical layer protocol data unit are impacted by interference in accordance with a value of the one or more medium access control protocol data unit delimiters, wherein the one or more second portions of the plurality of portions are determined as unsuccessfully received in association with verifying that the one or more medium access control protocol data unit delimiters of the physical layer protocol data unit are impacted by the interference.

6. The apparatus of claim 1, wherein the feedback field indicates one or more subchannels associated with the at least one in-device error.

7. The apparatus of claim 6, wherein the processing system is further configured to cause the apparatus to:
receive a retransmission of the physical layer protocol data unit in association with transmitting the block acknowledgement frame, wherein the one or more subchannels are punctured in the retransmission in accordance with the feedback field indicating the one or more subchannels.

8. The apparatus of claim 6, wherein the feedback field indicates a respective reason for the at least one in-device error for each subchannel of the one or more subchannels.

9. The apparatus of claim 1, wherein the feedback field indicates a level of interference of the at least one in-device error, the level of interference comprising a received signal strength indicator, a signal-to-interference noise ratio, or both.

10. The apparatus of claim 1, wherein the first portion of the physical layer protocol data unit is included in a physical layer header of the physical layer protocol data unit.

11. The apparatus of claim 1, wherein the block acknowledgement frame is communicated in accordance with a format, and wherein the format defines a conditional presence of one or more octets that include dynamic unavailability operation information.

12. The apparatus of claim 11, wherein a presence of the one or more octets that include the dynamic unavailability operation information corresponds to a first transmission scheme for the block acknowledgement frame, and wherein an absence of the one or more octets that include the dynamic unavailability operation information corresponds to a second transmission scheme for the block acknowledgement frame.

13. The apparatus of claim 12, wherein the first transmission scheme and the second transmission scheme align an end time of the block acknowledgement frame with an end of a transmission opportunity obtained by a second wireless device that transmits the physical layer protocol data unit in accordance with the presence or the absence, respectively, of the one or more octets that include the dynamic unavailability operation information within the block acknowledgement frame.

14. The apparatus of claim 1, wherein the response solicited from the first wireless device is an immediate response.

15. A method for wireless communications at a first wireless device, comprising:
receiving a physical layer protocol data unit comprising a plurality of portions, at least a first portion of the plurality of portions including an identifier of the first wireless device and soliciting a response from the first wireless device; and
transmitting, in accordance with successfully receiving at least the first portion of the plurality of portions and unsuccessfully receiving one or more second portions of the plurality of portions, a block acknowledgement frame in response to the physical layer protocol data unit, the block acknowledgement frame comprising a feedback field indicating:
at least one in-device error associated with the one or more second portions of the plurality of portions, and
one or more reasons for the at least one in-device error.

16. The method of claim 15, wherein the one or more reasons for the at least one in-device error comprise internal interference, coexistence interference, memory usage at the first wireless device, external interference, or any combination thereof.

17. The method of claim 15, wherein the one or more reasons for the at least one in-device error implicitly indicate that a same coding rate can be used for a retransmission of the physical layer protocol data unit.

18. The method of claim 15, wherein the one or more reasons for the at least one in-device error comprise channel conditions between the first wireless device and a second wireless device, and wherein the one or more reasons for the at least one in-device error implicitly request the second wireless device to adjust a coding rate for a retransmission of the physical layer protocol data unit.

19. The method of claim 15, further comprising:
verifying that one or more medium access control protocol data unit delimiters of the physical layer protocol data unit are impacted by interference in accordance with a value of the one or more medium access control protocol data unit delimiters, wherein the one or more second portions of the plurality of portions are determined as unsuccessfully received in association with verifying that the one or more medium access control protocol data unit delimiters of the physical layer protocol data unit are impacted by the interference.

20. A non-transitory computer-readable medium storing code for wireless communications, the code comprising instructions executable by one or more processors of a first wireless device to:
receive a physical layer protocol data unit comprising a plurality of portions, at least a first portion of the plurality of portions including an identifier of the first wireless device and soliciting a response from the first wireless device; and
transmit, in accordance with successfully receiving at least the first portion of the plurality of portions and unsuccessfully receiving one or more second portions of the plurality of portions, a block acknowledgement frame in response to the physical layer protocol data unit, the block acknowledgement frame comprising a feedback field indicating:
at least one in-device error associated with the one or more second portions of the plurality of portions, and
one or more reasons for the at least one in-device error.
